(19) United States
(12) Patent Application Publication
(10) Pub. No.: US 2026/0089584 A1
(43) Pub. Date: Mar. 26, 2026

(54) CONFIGURATION FOR CONDITIONAL CELL OPERATION

(71) Applicant: Nokia Technologies Oy, Espoo (FI)

(72) Inventors: Nihar Ranjan JENA, Bangalore (IN); Halit Murat GÜRSU, Munich (DE); Ahmad AWADA, Munich (DE); Ayaz AHMED, Bangalore (IN); Panagiotis SPAPIS, Munich (DE); Prasna Kumar SAHU, Bangalore (IN); Umur KARABULUT, Munich (DE); Srinivasan SELVAGANAPATHY, Bangalore (IN)

(21) Appl. No.: 19/103,437

(22) PCT Filed: Jun. 26, 2023
(86) PCT No.: PCT/EP2023/067320

§ 371 Date: Feb. 12, 2025

(30) Foreign Application Priority Data
Aug. 16, 2022 (IN) 202241046531

(51) Int. Cl. H04W 36/00

(52) U.S. Cl. CPC H04W 36/00835; H04W 36/0069

(57) ABSTRACT

The disclosure inter alia relates to a user equipment configured to support dual connectivity operation towards a master node and a secondary node of a radio access network, the user equipment comprising at least one processor and at least one memory, the at least one memory storing instructions that, when executed by the at least one processor, cause the user equipment to obtain, from the master node, conversion information configuring the user equipment to at least in part re-use a configuration pertaining to a first conditional cell operation regarding one or more secondary nodes for a subsequent second conditional cell operation regarding the one or more secondary nodes.

### TECHNOLOGICAL FIELD

The present disclosure is related to, but not limited to, dual connectivity operation in the context of radio access networks, as defined by the 3rd Generation Partnership Project (3GPP) standard, such as the 5G standard which is also referred to as New Radio (NR).

### BACKGROUND

Dual connectivity (DC) is a mode of operation where a user equipment (UE), which is capable of multiple transmission and reception, is configured to utilise resources provided by two different radio nodes. One node acts as master node (MN) and the other node acts as secondary node (SN). The MN and SN are connected via a network interface and at least the MN is connected to the core network. A master cell group (MCG) is a group of at least one serving cell associated with the MN, and a secondary cell group (SCG) is a group of at least one serving cell associated with the SN. The master cell group comprises at least one primary cell (PCell). The secondary cell group also comprises at least one primary cell of the secondary cell group or primary secondary cell (PSCell). The respective primary cells can be understood to be the cells over which the UE establishes the connection or initial access to the respective cell group (see e.g. references [1], [2]).

There are different operations in order to e.g. add, modify, release or change the respective secondary nodes or PSCells. These operations may be required e.g. because the UE is moving and may leave or enter the coverage area of the respective cells or nodes. It is also possible to implement these operations as conditional operations by configuring the UE with a certain configuration for such operations, but the UE will only execute the operation (e.g. connect to another secondary node or cell) when a certain execution condition, which is provided in the configuration and monitored by the UE, is met. For instance, a conditional PSCell addition (CPA) is defined as a PSCell addition that is executed by the UE when execution condition(s) is met. The UE starts evaluating the execution condition(s) upon receiving the CPA configuration, and stops evaluating the execution condition(s) once PSCell addition or PCell change is triggered. Likewise, a conditional PSCell change (CPC) is defined as a PSCell change that is executed by the UE when execution condition(s) is met. The UE starts evaluating the execution condition(s) upon receiving the CPC configuration, and stops evaluating the execution condition(s) once PSCell change or PCell change is triggered. Usually the UE is provided with multiple prepared candidate secondary nodes or PSCells for the respective operation, to one of which the UE will then establish a connection or change from a previous secondary node or PSCell for a dual connectivity operation. The configuration for the remaining or un-used candidate secondary nodes or PSCells is then released.

### SUMMARY OF SOME EXEMPLARY EMBODIMENTS

Considering the case of an SN or PSCell addition, for instance, and assuming that the SN or PSCell is successfully added in a conditional PSCell addition (CPA) procedure, the CPA configuration of other candidate PSCells are released at UE and the configuration or reserved resources are also cancelled in the other candidate PSCells not selected or connected to by the UE. Thus, for a subsequent PSCell change (after said successful first CPA), the conditional reconfiguration and preparation of the target SNs needs to be initiated again (but this time for a change procedure, CPC, not an addition procedure, CPA). For this, the CPC configuration(s) need to be requested from the candidate target cells and the CPC condition needs to be configured which will induce delay and signalling overhead.

Likewise, considering the case of a conditional PSCell change (CPC) initiated by the SN, the UE may be configured with a CPC configuration and may monitor respective conditions, but there may be a failure (e.g. a sync failure) before the actual change can be executed. In that case, an SN release message is initiated releasing the serving or source secondary node and resulting in cancelling of all the prepared PSCells at the target SN and initiates the release of entire SCG configuration and related UE context at the target SNs.

Either case results in delay and increased signaling overhead for the required subsequent preparation of a conditional PSCell addition or change to other target SNs.

Thus, certain embodiments of the present disclosure may provide an improved approach of configuring a (subsequent) conditional cell operation. Certain embodiments of the present disclosure may have the effect of reducing the delay and/or signaling overhead for a subsequent preparation of a conditional PSCell addition or change to other target SNs. Certain embodiments of the present disclosure may have the effect of a faster SN addition immediately after an SN release. Certain embodiments of the present disclosure may have the effect of a faster PSCell change to a further SN immediately after the SN addition. Certain embodiments of the present disclosure may have the effect of re-using or converting configurations for conditional cell operations.

According to a first exemplary aspect a user equipment is disclosed. The user equipment may be configured to support dual connectivity operation towards a master node and a secondary node of a radio access network. The user equipment may comprise at least one processor and at least one memory. The at least one memory may store instructions that, when executed by the at least one processor, cause the user equipment to obtain, from the master node, conversion information. The conversion information may configure the user equipment to at least in part re-use a configuration pertaining to a first conditional cell operation regarding one or more secondary nodes for a subsequent second conditional cell operation regarding the one or more secondary nodes.

According to a second exemplary aspect a master node of a radio access network is disclosed. The master node and a secondary node of the radio access network may be configured to support dual connectivity operation towards a user equipment. The master node may comprise at least one processor and at least one memory. The at least one memory may store instructions that, when executed by the at least one processor, cause the master node to provide, to the user equipment, conversion information. The conversion information may configure the user equipment to at least in part re-use a configuration pertaining to a first conditional cell operation regarding one or more secondary nodes for a subsequent second conditional cell operation regarding the one or more secondary nodes.

According to each of the exemplary aspects, a respective method is also disclosed.

Thus, according to the first exemplary aspect, there is also disclosed a method, performed by a user equipment configured to support dual connectivity operation towards a master node and a secondary node of a radio access network. The method may comprise at least obtaining, from the master node, conversion information. The conversion information may configure the user equipment to at least in part re-use a configuration pertaining to a first conditional cell operation regarding one or more secondary nodes for a subsequent second conditional cell operation regarding the one or more secondary nodes.

Thus, according to the second exemplary aspect, there is also disclosed a method performed by a master node of a radio access network. The master node and a secondary node of the radio access network may be configured to support dual connectivity operation towards a user equipment. The method may comprises at least providing, to the user equipment, conversion information. The conversion information may configure the user equipment to at least in part re-use a configuration pertaining to a first conditional cell operation regarding one or more secondary nodes for a subsequent second conditional cell operation regarding the one or more secondary nodes.

The user equipment may be a stationary device or a mobile device. In particular, the user equipment may be a mobile device, such as a smartphone, a tablet, a wearable, a smartwatch, a low power device, an IoT device, an IloT device, a vehicle, a truck, a drone, an airplane, or the like. The user equipment may in particular be capable of communicating with (transmitting and receiving signals and/or data to/from) one or more other user equipments. Additionally or alternatively, the user equipment may in particular be capable of communicating with (transmitting and receiving signals and/or data to/from) at least one master node of a radio access network, the master node configured to support dual connectivity operation towards a secondary node of the radio access network and the user equipment. Additionally or alternatively, the user equipment may in particular be capable of communicating with (transmitting and receiving signals and/or data to/from) at least one secondary node of a radio access network, the secondary node configured to support dual connectivity operation towards a master node of the radio access network and the user equipment. Generally, the user equipment may also be any device enabled for communication with a communication network and/or another user equipment.

A radio node (e.g. a master node or a secondary node) may be understood as a wireless communication station installed at a fixed or mobile location and may in particular be or comprise an entity of a radio access network of a wireless communication system. For instance, the radio node may be, comprise, or be part of a base station of a wireless communication network of any generation (e.g. a gNB, ng-eNB, eNodeB, NodeB, BTS or the like) of a 3GPP standard. Generally, the radio node may be or comprise a hardware or software component implementing a certain functionality. In an example, the radio node may be or comprise a location management function (LMF). In an example, the radio node may be an entity as defined by 3GPP 5G or NR standard (also referred to as gNB). In one example the radio node may be or comprise a gNB-CU-CP node. Accordingly, while the radio node may be understood to be implemented in or be a single device or module, the radio node may also be implemented across or comprise multiple devices or modules. As such, the radio node may in particular be implemented in or be a stationary device. Multiple radio nodes may in particular establish a wireless communication system or network, which may in particular be an NR or 5G system or any other wireless communications system defined by a past or future standard, in particular successors of the present 3GPP standards. In particular, multiple radio nodes, for example a master node and one or more secondary nodes, may be configured to support dual connectivity operation towards one or more user equipments. The radio node may be capable of being in direct and/or indirect communication with other radio nodes or with user equipment.

The means or functionality of any of the disclosed devices or apparatuses (i.e. any of the user equipment and any radio node) can be implemented in hardware and/or software. Generally, the described apparatuses may comprise means for performing or causing the described functions. They may comprise one or multiple modules or units providing the respective functionality. They may for instance comprise at least one processor for executing computer program code for performing the required functions, at least one memory storing the program code, or both. Alternatively, they could comprise for instance circuitry that is designed to implement the required functions, for instance implemented in a chipset or a chip, like an integrated circuit. In general, the means may comprise for instance one or more processing means or processors.

A master node may e.g. implement CU-CP and/or CP-UP functionality. The functionalities may also be implemented using specific means configured to perform respective specific tasks, e.g. layer 3 means to perform layer 3 operations, layer 2 means to perform layer 2 operations, etc. The master node may include e.g. conversion means configured to provide, to the user equipment, conversion information configuring the user equipment to at least in part re-use a configuration pertaining to a first conditional cell operation regarding one or more secondary nodes for a subsequent second conditional cell operation regarding the one or more secondary nodes.

Similarly the user equipment may include specific means to perform specific tasks, e.g. obtaining means configured to obtain, from the master node, conversion information configuring the user equipment to at least in part re-use a configuration pertaining to a first conditional cell operation regarding one or more secondary nodes for a subsequent second conditional cell operation regarding the one or more secondary nodes.

Thus, according to the respective exemplary aspects of the present disclosure, there is in each case also disclosed a respective apparatus (i.e. a terminal device and a network device) comprising means to cause the respective apparatus at least to perform a method according to the respective aspect of the present disclosure.

Any of the above-disclosed exemplary aspects may, however, in general be performed by an apparatus, which may be a module or a component for a device, for example a chip. The disclosed apparatus may comprise the disclosed components, for instance means, processor, memory, or may further comprise one or more additional components.

According to the exemplary aspects of the present disclosure, there is in each case also disclosed a computer program, the computer program when executed by a processor of an apparatus causing said apparatus to perform a method according to the respective aspect.

The computer program may in each case be stored on computer-readable storage medium, in particular a tangible and/or non-transitory medium. The computer readable storage medium could for example be a disk or a memory or the like. The computer program could be stored in the computer readable storage medium in the form of instructions encoding the computer-readable storage medium. The computer readable storage medium may be intended for taking part in the operation of a device, like an internal or external memory, for instance a Read-Only Memory (ROM) or hard disk of a computer, or be intended for distribution of the program, like an optical disc.

Accordingly, according to the first exemplary aspect, there is inter alia disclosed a non-transitory computer-readable medium comprising program instructions that, when executed by a user equipment configured to support dual connectivity operation towards a master node and a secondary node of a radio access network, cause the user equipment to obtain, from the master node, conversion information configuring the user equipment to at least in part re-use a configuration pertaining to a first conditional cell operation regarding one or more secondary nodes for a subsequent second conditional cell operation regarding the one or more secondary nodes.

Likewise, according to the second exemplary aspect, there is inter alia disclosed non-transitory computer-readable medium comprising program instructions that, when executed by a master node of a radio access network, the master node and a secondary node of the radio access network configured to support dual connectivity operation towards a user equipment, cause the master node to provide, to the user equipment, conversion information configuring the user equipment to at least in part re-use a configuration pertaining to a first conditional cell operation regarding one or more secondary nodes for a subsequent second conditional cell operation regarding the one or more secondary nodes.

The user equipment may have established a connection (at least) with the master node. The master node may provide a master cell group (MCG). The user equipment may have a connection to the primary cell (PCell) of the master cell group. For instance, the user equipment and the master node or PCell may communicate with an RRC signalling connection.

The user equipment may also have established or want to establish a connection with a secondary node. The secondary node may provide or be part of a secondary cell group (SCG). The user equipment may have or establish a connection to the primary cell (PSCell) of the secondary cell group. For instance, the user equipment and the secondary node or PSCell may communicate with an RRC signalling connection.

Generally, a connection of a user equipment is considered to be towards cells, while a cell is however provided by a respective node. Thus, the terms node and its associated cell may be used interchangeably in the present disclosure. In the context of dual connectivity a user equipment usually has (or tries to obtain) connections to (at least) two different cells, the primary cell, PCell, of the (serving or source) master node and the primary secondary cell (i.e. the primary cell of the secondary cell group), PSCell of the (serving or source) secondary node. The conditional cell operation regarding a secondary nodes is thus related to the PSCells of the target secondary nodes (e.g. to switch to or to be added). Therein, the source secondary node (to which the user equipment is already connected or from which it is switching) is generally different from the target secondary nodes (one of which is to be added or switched to).

A cell operation may in particular be understood to be an operation or procedure performed with respect to a secondary node or cell (e.g. PSCell). A cell operation may in particular comprise or be the addition, change, release, modification of a secondary node or cell (e.g. PSCell). In an addition procedure for a secondary node or cell, the UE may add a secondary node or primary secondary cell in addition to the master node or primary cell. In a change procedure for a secondary node or cell, the UE may change from a source secondary node, S-SN, or serving primary secondary cell, serving PSCell, to a target secondary node, T-SN, or target primary secondary cell, target PSCell. For instance, a conditional cell operation may be a conditional PSCell addition (CPA) or a conditional PSCell change (CPC), which may also be referred to together as conditional PSCell addition or change (CPAC).

Conversion information may generally be understood to be any information enabling a user equipment to at least in part re-use a configuration pertaining to a first conditional cell operation for a subsequent second conditional cell operation. The conversion information may for instance comprise information on how to use, update and/or modify the configuration pertaining to a first conditional cell operation so that it can be used for the subsequent second conditional cell operation. The conversion information may be understood to configure the user equipment for the subsequent second conditional cell operation based on the configuration of the first conditional cell operation. Accordingly, the conversion information may be seen as or termed “configuration information” for a conditional cell operation. The conversion information may be understood to align the configuration pertaining to a first conditional cell operation of the user equipment, so that it can be re-used for the subsequent second conditional cell operation. Accordingly, the conversion information may be understood to be or termed “alignment information”. The potential contents or information comprised by the conversion information are described in more detail below.

The configuration pertaining to the first conditional cell operation may have previously been received by the user equipment from the master node (e.g. in a previous message). However, the configuration pertaining to a first conditional cell operation and the conversion information may also be obtained together (e.g. in a common message) from the master node.

As the configuration pertaining to a first conditional cell operation regards one or more secondary nodes, the configuration may be understood to comprise multiple (individual) configurations, e.g. one for each of the one or more secondary nodes. These individual configurations may be individually maintained, modified and/or re-used, for instance.

The one or more secondary nodes may comprise candidate secondary nodes, which may be secondary nodes usable by the user equipment for dual connectivity. The secondary nodes may provide or be associated with candidate primary secondary cells, PSCells. For instance, if the conditions are met, the user equipment may (try to) establish a connection to a respective secondary node or PSCell by means of the respective conditional cell operation, which has been configured with a respective configuration. Usually, only one of the candidate cells or nodes is selected by the UE for the respective cell operation (e.g. to be added or changed to).

Generally, a configuration for a conditional cell operation may be received by the user equipment, for instance in a higher layer configuration message, such as an RRC configuration message, e.g. RRCReconfiguration. A configuration pertaining to a certain conditional cell operation may in particular comprise information regarding the one or more conditions to be met. The conditions may be referred to as execution conditions. The user equipment will use the configuration in order to monitor whether the one or more conditions are met. In case the condition(s) are met, the user equipment will apply or execute the configuration and thereby performing the respective operation (e.g. cell addition or cell change).

The one or more secondary nodes of the first conditional cell operation may at least in part be the same as the one or more secondary nodes of the second conditional cell operation. In an example, only a part of the one or more secondary nodes, to which the first conditional cell operation pertains, may be re-used for the second conditional cell operation. In an example, all of the one or more secondary nodes to which the first conditional cell operation pertains, may be re-used for the second conditional cell operation.

Re-using at least a part of the configuration information is in particular understood to mean that the configuration (or a part thereof) for at least one of the one or more secondary nodes or secondary cells may be re-used. For instance, configuration with respect all or some particular secondary cells or nodes may be re-used. However, the conversion information may modify or update the configuration pertaining to a first conditional cell operation. For instance, the conversion information may comprise information for modifying or updating the list of candidate secondary nodes or cells of the configuration when re-used. For instance, the conversion information may comprise information for modifying or updating the one or more execution conditions of one or more candidate secondary nodes or cells.

In an example, the configuration pertaining to the first conditional cell operation may comprise a configuration for at least two prepared candidate primary secondary cells, PSCells, of at least one (e.g. target) secondary node. A prepared primary secondary cell may be understood that the cell (or the associated secondary node) is informed about its potential use as a primary secondary cell or secondary node. For instance the secondary node may have received an SN Addition Request from the master node, so that the respective secondary node or the associated cell is prepared. For instance, the secondary node may have obtained UE context information for the respective user equipment.

Likewise, the configuration pertaining to the second conditional cell operation (which is at least in part based on or derived from the configuration pertaining to the first conditional cell operation) may comprise a configuration for at least two prepared candidate primary secondary cells, PSCells, of at least one (e.g. target) secondary node.

In an example, the user equipment may be configured to establish a dual connectivity connection towards a primary cell, PCell, of the master node, and a primary secondary cell, PSCell, of the secondary node. In order to establish or maintain the dual connectivity connection the user equipment is provided with respective configuration for conditional cell operations regarding the secondary nodes or primary secondary cells.

As will also become more apparent form the further examples provided herein, the described aspects may allow for an improved approach for a subsequent second conditional cell operation after a first (successful or unsuccessful) first conditional cell operation regarding one or more secondary nodes. More specifically, because the user equipment is able to at least partially re-use or convert a configuration regarding a first conditional cell operation for/into a second conditional cell operation, the user equipment is quickly and efficiently configured for the second conditional cell operation. This may have the effect of reducing the delay and/or signaling overhead for a subsequent preparation of a conditional PSCell addition or change to other target SNs.

In an example, the first conditional cell operation is a conditional cell change, in particular a conditional PSCell change, CPC, and wherein the subsequent second conditional cell operation is a conditional cell addition, in particular a conditional PSCell addition, CPA. As described above, there may be the case that the CPC is successfully configured (and the user equipment is monitoring the conditions provided in the CPC configuration) but not yet successfully executed or completed. Instead there may be a connection failure (such as a sync failure) between the user equipment and the serving secondary node resulting in a release of the connection to the secondary node. In this example, the described approach may have the effect of a faster SN addition immediately after an SN release, because the configuration originally provided to the user equipment for the purpose of the CPC procedure can be converted based on the conversion information e.g. into a configuration for a CPA and re-used for the CPA without additional delay or signalling.

In an example, the first conditional cell operation is a conditional cell addition, in particular a conditional PSCell addition, CPA, and wherein the subsequent second conditional cell operation is a conditional cell change, in particular a conditional PSCell change, CPC. For instance, the CPA may be successfully configured and executed. Instead of releasing the other candidate secondary nodes or PSCells, which have not be used for the CPA, the configuration for these other candidate secondary nodes or PSCells can be converted based on the conversion information into a configuration for a CPC and re-used for the CPC without additional delay or signalling allowing a faster PSCell change to a further SN immediately after the SN addition.

In an example, the user equipment may further obtain, from the master node, said configuration pertaining to said first conditional cell operation regarding one or more secondary nodes. For instance, the user equipment may receive a higher layer message, e.g. an RRC message such as a RRCReconfiguration message.

In an example, the configuration pertaining to said first conditional cell operation regarding one or more secondary nodes may be obtained in a first configuration message (e.g. RRCReconfiguration). The user equipment may then use the configuration pertaining to said first conditional cell operation and monitor whether the respective execution conditions are met. The first conditional cell operation may or may not yet be completed. Still, the UE may then obtain the conversion information in a subsequent second configuration message. The user equipment may then use the conversion information for obtaining the configuration pertaining to the subsequent second conditional cell operation. The user equipment may then replace the previous configuration and instead use the so derived configuration pertaining to the subsequent second conditional cell operation and monitor whether the respective execution conditions are met.

In an example, the configuration pertaining to said first conditional cell operation regarding one or more secondary nodes and said conversion information may be obtained in a common configuration message. The user equipment may first use the configuration pertaining to said first conditional cell operation and monitor whether the respective execution conditions are met. As described in more detail below, the conversion information may indicate to maintain or not release the configuration regarding other candidate secondary nodes. Rather, after the first conditional cell operation is complete, the UE may then directly use the configuration pertaining to the subsequent second conditional cell operation also received with the common configuration message.

In an example, the described first, second and/or common configuration message may each be a higher layer message, in particular an RRCReconfiguration message. Each respective message may for example comprise one or more RRCReconfigurations for respective conditional cell operations.

In different examples, the conversion information may comprise one or more of the following information.

For instance, the conversion information may comprise an indication to maintain a configuration pertaining to a source secondary node, S-SN, or a serving secondary cell group, SCG, for said re-use of the configuration for the subsequent second conditional cell operation. For instance, in the case of re-using a CPC configuration at least in part for a CPA operation, the conversion information may comprise an indication to not release a configuration pertaining to a S-SN or SCG, but rather to promote the configuration to be used for CPA.

For instance, the conversion information may comprise an indication to maintain a configuration pertaining to one or more target secondary nodes, T-SN, or target secondary cell groups, SCG, for said re-use of the configuration for the subsequent second conditional cell operation.

An indication to maintain a configuration may be an implicit or explicit indication. In an example, the indication may be a bit or flag indicating to maintain or not release one or more (or all) configurations. In an example, an indication to maintain a configuration may be realized by not including the respective SNs, SCGs or PSCells, to which the configuration pertains (e.g. respective IDs thereof), on a release list.

In an example, the conversion information may comprise an information indicating an updated measurement gap for said re-use of the configuration for the subsequent second conditional cell operation. For instance, the configuration pertaining to the first conditional cell operation may comprise a first measurement gap. The conversion information may comprise a second measurement gap to be used for the subsequent second conditional cell operation.

In an example, the conversion information may comprise information indicating one or more updated execution conditions for said re-use of the configuration for the subsequent second conditional cell operation. For instance, the configuration pertaining to the first conditional cell operation may comprise one or more first execution conditions. The conversion information may comprise one or more second execution conditions to be used for the subsequent second conditional cell operation.

In an example, the conversion information may comprise an indication to maintain, after a successful execution of the first conditional cell operation towards one secondary node, the configuration pertaining to the one or more remaining secondary nodes for said re-use of the configuration for the subsequent second conditional cell operation. For this, as described above, the conversion information may in particular comprise a flag indicating to not release the other or remaining secondary nodes. For instance, in the case of re-using a CPA configuration at least in part for a CPC operation, the conversion information may comprise a flag not to release the other secondary nodes after a (successful) SN addition.

In an example, the conversion information may comprise information indicating one or more execution conditions to be used for the first conditional cell operation and one or more execution conditions to be used for the subsequent second conditional cell operation. The one or more execution conditions to be used for the subsequent second conditional cell operation can be used to (at least in part) replace the one or more execution conditions for the first conditional cell operation.

In an example, the user equipment may further, in response to obtaining said configuration pertaining to said first conditional cell operation, start evaluating one or more execution conditions based on the configuration pertaining to the first conditional cell operation. In an example, the user equipment may obtain the conversion information before the one or more execution conditions based on the configuration pertaining to the first conditional cell operation are met or before the execution of the first conditional cell operation is completed. This may be due to a connection failure regarding serving SN or SCG, which may therefore indicate the requirement of a release to the master node. As a response the master node may inter alia provide the conversion information to the user equipment so that the already configured conditional cell operations may be re-used instead of released. In an example, the user equipment may, in response to obtaining said conversion information, start evaluating one or more execution conditions based on the re-used configuration for the second conditional cell operation. The user equipment may thus be enabled to e.g. quickly add again any of the source or target secondary nodes from a previous unsuccessful conditional cell operation.

In an example, the user equipment may further, in response to obtaining said configuration pertaining to said first conditional cell operation, start evaluating one or more execution conditions based on the configuration pertaining to the first conditional cell operation. The user equipment may then determine whether the one or more execution conditions for the configuration pertaining to the first conditional cell operation are met. In case it is determined by the user equipment that the one or more execution conditions for the configuration pertaining to the first conditional cell operation are met, the user equipment may execute or apply the configuration pertaining to the first conditional cell operation, and start evaluating one or more execution conditions based on the re-used configuration for the second conditional cell operation.

In an example, the user equipment may further determine whether the one or more execution conditions for the re-used configuration for the second conditional cell operation are met. In case it is determined by the user equipment that the one or more execution conditions for the re-used configuration for the second conditional cell operation are met, the user equipment may execute or apply the re-used configuration for the second conditional cell operation.

In an example, the configuration pertaining to the first conditional cell operation comprises a full configuration or delta configuration the first conditional cell operation. The respective configuration (e.g. a full RRC configuration or a delta RRC configuration) may first be sent from the respective secondary node to the master node. The master node may then provide the respective configuration to the user equipment. In case of a delta configuration, the user equipment can construct a full configuration for a reference configuration in combination with the delta configuration.

In an example, the user equipment may further determine whether the re-used configuration for the subsequent second conditional cell operation pertains to a number of candidate secondary cells exceeding a predetermined number. The predetermined number may for instance be between 2 and 20. In an example the predetermined number is 8. In case it is determined by the user equipment that the number of candidate secondary cells to which the re-used configuration for the subsequent second conditional cell operation pertains exceeds the predetermined number, the user equipment may remove one or more candidate secondary cells from the re-used configuration for the subsequent second conditional cell operation. For instance, the user equipment may remove the last target candidate cell configuration.

In an example, the master node may further obtain, from a source secondary node, S-SN, an indication to release the source secondary node, wherein, in response to said indication to release the source secondary node, said conversion information is provided to the user equipment. When receiving an indication to release the S-SN (e.g. SN Release Required), the source secondary node may provide to the master node (e.g. in the Release Required message) updated information e.g. regarding the execution conditions and/or the measurement gap, to be used for this secondary node after being release and when being a candidate for the subsequent second conditional cell operation. Accordingly, in an example, said indication to release the source secondary node may comprise information indicating an updated measurement gap for said re-use of the configuration for the subsequent second conditional cell operation. Accordingly, in an example, said indication to release the source secondary node may additionally or alternatively comprise information indicating an updated execution condition for said re-use of the configuration for the subsequent second conditional cell operation. This information may be used or forwarded by the master node in the conversion information.

In an example, the master node may further update one or more execution conditions to be indicated to the user equipment as part of the conversion information for said re-use of the configuration for the subsequent second conditional cell operation. As described above, the master node may update the one or more execution conditions based on information received from one or more respective secondary nodes, which may be candidate nodes for the subsequent second conditional cell operation.

In an example, the master node may further refrain from releasing a configuration pertaining to one or more target secondary nodes, target secondary cell groups and/or primary secondary cells to be re-used for the subsequent second conditional cell operation.

Any of the described examples may equally apply to any of the described aspects. In particular, the disclosure of a method step shall also be considered as a disclosure of means for performing the respective method step. Likewise, the disclosure of means for performing a method step shall also be considered as a disclosure of the method step itself. However, it is to be understood that the presentation of the embodiments disclosed herein is merely by way of examples and non-limiting.

Other features of the present disclosure will become apparent from the following detailed description considered in conjunction with the accompanying drawings. It is to be understood, however, that the drawings are designed solely for purposes of illustration and not as a definition of the limits of the present disclosure, for which reference should be made to the appended claims. It should be further understood that the drawings are not drawn to scale and that they are merely intended to conceptually illustrate the structures and procedures described herein.

### BRIEF DESCRIPTION OF THE FIGURES

Some example embodiments will now be described with reference to the accompanying drawings in which

FIGS. 1a-1d show, in a signalling flow chart, a first exemplary embodiment according to the different aspects of the disclosure;

FIGS. 2a-2d show, in a signalling flow chart, a second exemplary embodiment according to the different aspects of the disclosure;

FIGS. 3a-3b show, in a signalling flow chart, a third exemplary embodiment according to the different aspects of the disclosure;

FIG. 4 shows, in a schematic block diagram, an example embodiment of a user equipment according to the first aspect;

FIG. 5 shows, in a schematic diagram, an example embodiment of a radio node, such as a master node or a secondary node, according to the second aspect;

FIG. 6 shows, in a schematic illustration, examples of tangible and non-transitory computer-readable storage media according to the different aspects; and

FIG. 7 exemplarily illustrates, in a schematic diagram, a radio environment in which example embodiments of the present disclosure may be performed.

### DETAILED DESCRIPTION OF THE FIGURES

The following description serves to deepen the understanding of the present disclosure and shall be understood to complement and be read together with the description of example embodiments of the present disclosure as provided in the above SUMMARY section of this specification.

In the following and with reference to FIG. 7, an example radio environment, in which the present disclosure may be applied, is described. While the specific radio system in the examples below is a 5G system, this is only to be considered a non-limiting example.

FIG. 7 exemplarily illustrates, as an example of a UE according to the first exemplary aspect, a user equipment (UE) 701. FIG. 7 further illustrates, as an example of a MN according to the second exemplary aspect, a master node (MN) 702. FIG. 7 further illustrated examples of SNs, a source secondary node (S-SN) 703, a first target secondary node (T-SN1) 704, and a second target secondary node (T-SN2) 705. Together, MN 702, S-SN 703, T-SN1 704 and T-SN2 705 may establish a wireless communication system or network serving a geographical area within which UE 701 is located. UE 701, MN 702 and SNs 703, 704, 705 may be operating in dual connectivity mode.

UE 701 may be connected with MN 702 and with one or more of SNs 703, 704, 705 by means of radio links (not shown), which may for example correspond to the 5G/NR Uu interface. MN 702 may be connected with one or more of SNs 703, 704, 705 by means of radio links (not shown), which may for example correspond to the 5G/NR Xn interface. The radio links may enable transmitting and/or receiving of information and/or signals in between the respective devices.

The MN 702 may provide a primary cell (PCell) and/or one or more secondary cells (SCells) of a master cell group (MCG). Any of the secondary nodes 703, 704, 705 may provide a primary secondary cell (PSCell) and one or more secondary cells (SCells) of a secondary cell group (SCG).

At some point in time, as indicated by the arrow 770, UE 701 moves from a first position to a second position. At the first position the UE may have been served by a PSCell of the source secondary node S-SN 703, which may have been added with a conditional PSCell addition (CPA). PSCell associated with target secondary node T-SN1 704 may be serving the UE at the second position. Thus, during the movement of UE 701 along arrow 770, a conditional PSCell change (CPC) of UE 701 from S-SN 703 to T-SN1 704 may have been performed.

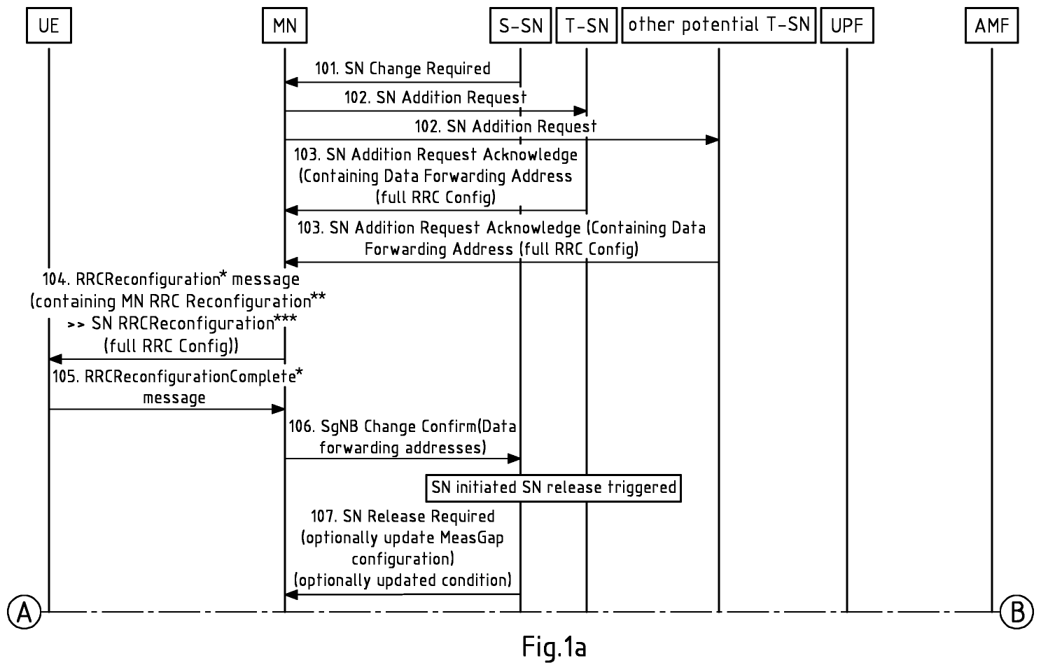

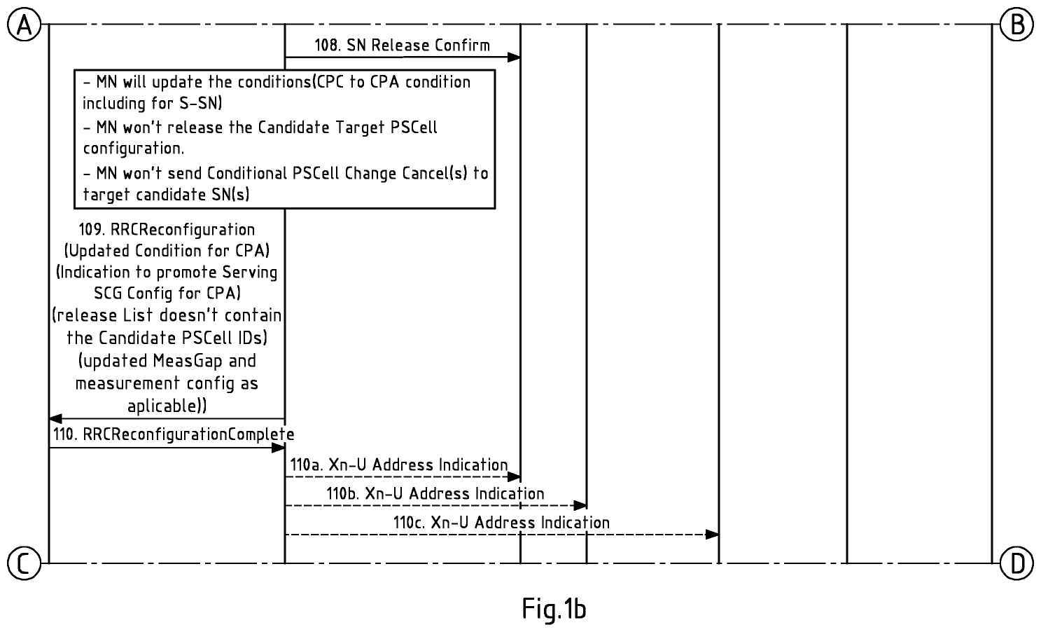

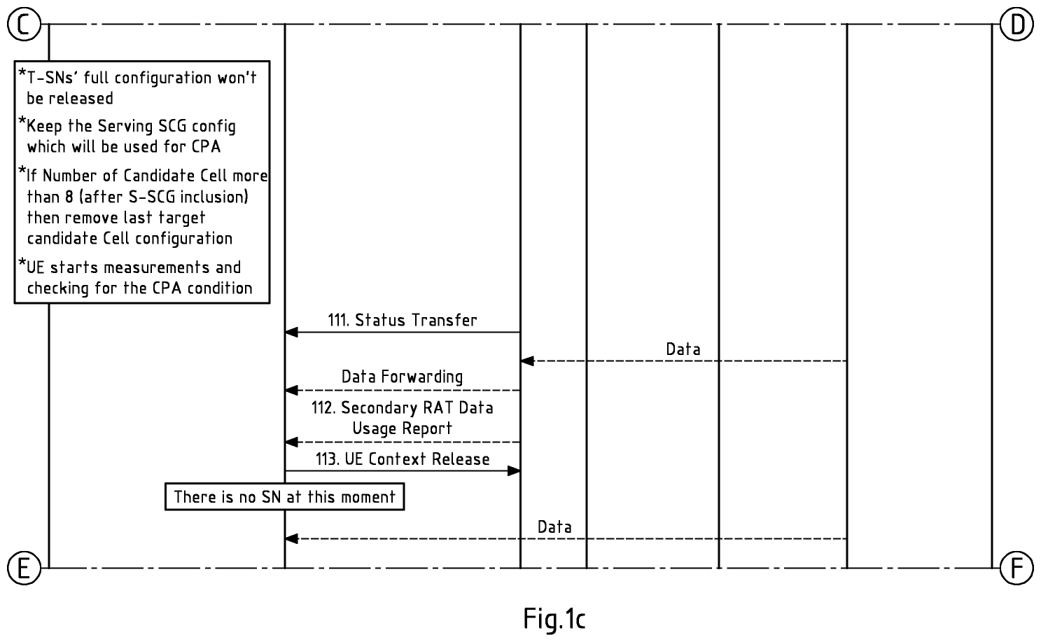

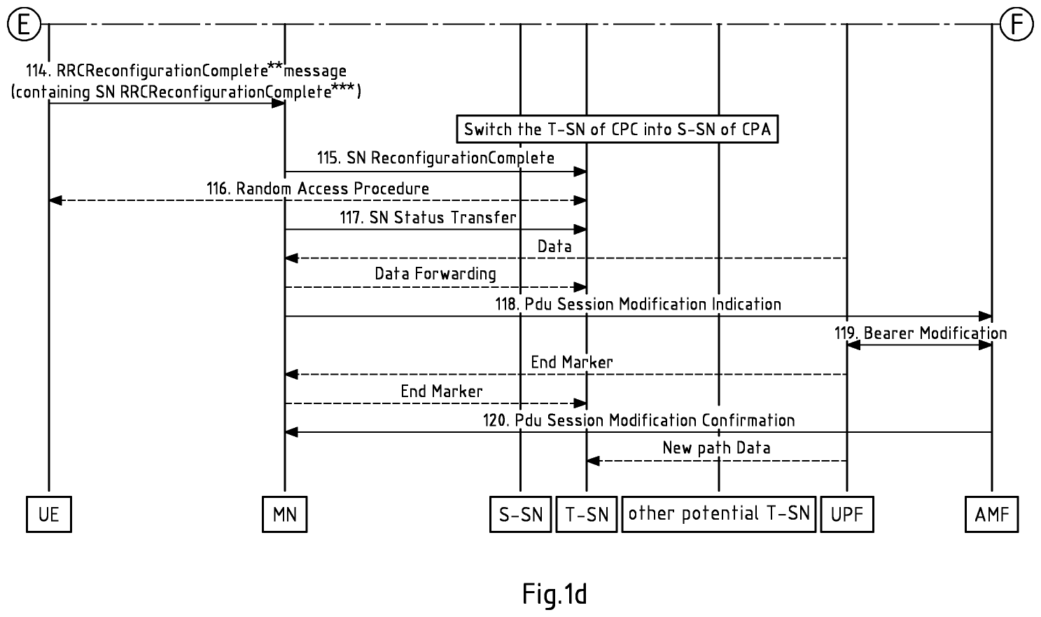

In the following, the two scenarios mentioned above of a conditional PSCell change and of a conditional PSCell addition will be explained in more detail for a general understanding. As will become apparent and explained in more detail thereafter with respect to FIGS. 1a-d, 2a-d, 3a-b, the aspects of the present disclosure may be advantageously employed in these exemplary scenarios The Inter-SN conditional PSCell change (CPC) is specified in Rel-17, where the procedure could be initiated by either the MN or the SN, see for instance Section 10.5.2, FIG. 10.5.2-4 of [2]. The steps of the SN initiated inter-SN CPC procedure can be described as follows:
The SN initiated CPC may be initiated by the source SN, to modify the existing CPC configuration or to trigger the release of target SN by cancelling all the prepared PSCells and releasing CPC related UE context at the target SN.
In SN initiated CPC, the source SN suggests the PSCell candidates, decides on the CPC execution conditions and may also include SCG measurement configurations for CPC. It is the target SN that decides the list of PSCells to prepare and includes the list of PSCell IDs to the MN together with the indication of full or delta RRC configuration.
In case e.g. the target SN did not prepare all the suggested PSCells the MN may indicate the candidate PSCells accepted by the target SN to the source SN via ‘SN Modification Request’ message. The source SN may provide the updated measurement configurations and the execution conditions to the MN via ‘SN Modification Request Acknowledge’ message.
The MN reconfigures the UE with CPC configurations and the associated execution conditions. The UE applies the RRC configuration and stores the CPC configuration, provided it complies with the received configuration (otherwise performs reconfiguration failure procedure).
The source SN may further trigger an update of CPC execution condition and corresponding SCG measConfig for CPC via ‘SN Modification Required’ message enabling the MN to reconfigure the UE.
The UE starts evaluating the execution conditions. If the execution condition of one candidate PSCell is satisfied, the UE applies ‘RRCReconfiguration’ message corresponding to the selected candidate PSCell, and sends an ‘RRCReconfiguration complete’ message, including the selected PSCell information to the MN.
The MN triggers the MN initiated SN Release procedure to inform the source SN to stop providing user data to the UE and triggers the Xn-U Address Indication procedure to inform the source SN the address of the selected target SN for data forwarding.
The MN also informs the target SN the successful RRC connection reconfiguration via ‘SN Reconfiguration Complete’ message. And subsequently the MN sends the ‘SN Release Request’ messages to cancel CPC in the other target candidate SNs, if configured.
Following a ‘RRCReconfiguration complete’ message, the UE synchronizes to the target SN (Random Access Procedure).

However, when SN-initated CPC is configured, the SN release message, that is initiated for instance due to a sync failure, results in cancelling of all the prepared PSCells at the target SN and initiates the release of entire SCG configuration and related UE context at the target SNs.

Note, there can be a time gap between CPC configuration and condition configured at the UE and the UE triggering the RRCReconfigurationComplete for the target PSCell (upon CPC condition met). In between, there is chance of triggering SN-initiated SN Release procedure.

Further note, in case of an SN initiated Release (i.e. “SN Release Required”), there is no reject message defined in 38.423 (section 8.3.7.3.-Unsuccessful Operation is “Not applicable”). Also when this SN initiated Release is triggered, the actual SN change procedure (CPC execution) may not be triggered yet.

The Conditional PSCell addition (CPA) is also specified in Rel-17 and the procedure is initiated by MN, see section 10.2, FIG. 10.2.2-2 of [2]. The steps of the CPA procedure can be described as follows:
In order to configure CPA for the UE, the MN requests the target candidate SN to allocate resources. The MN indicates the requested SCG configuration information and also provides the candidate cells suggested by the MN via the latest measurement results for the SN to choose and configure the SCG cell(s).
If the SN can admit the resource request, it allocates respective resources and communicate PSCell configuration(s) to the MN.
The MN reconfigures the UE with CPA configuration and the associated execution conditions. The UE applies the RRC configuration and stores the CPA configuration, provided it complies with the received configuration (otherwise performs reconfiguration failure procedure).
The UE starts evaluating the execution conditions. If the execution condition of one candidate PSCell is satisfied, the UE applies the ‘RRCReconfiguration’ message corresponding to the selected candidate PSCell and sends an ‘RRC reconfiguration complete’ message, including the selected PSCell information to the MN.
The MN informs the SN the successful RRC connection reconfiguration via the ‘SN Reconfiguration Complete’ message. Subsequently, the MN sends the ‘SN Release Request’ messages to cancel CPA in the other target candidate SNs, if configured.
Following a ‘RRC reconfiguration complete’ message, the UE synchronizes to the target SN (Random Access Procedure).
For the detailed flow diagram, please refer to “FIG. 10.2.2-2: Conditional Secondary Node Addition procedure” in TS 37.340”.

However, after the successful SN addition, the CPA configuration of the other remaining candidate PSCells are released at the UE and CPA is cancelled in the other candidate PSCells. So for a further PSCell change (after said successful CPA), the conditional reconfiguration and preparation of the target SNs needs to be initiated again (but this time a CPC should be configured, not a CPA). That is, the CPC configuration(s) need to be requested from the candidate target cells and the CPC condition needs to be configured which would induce delay and signalling overhead.

Thus, following a SN initiated inter-SN CPC successfully configured at the UE, if the source SN release is initiated (e.g., due to sync failure), the prepared PSCells at the target SN are cancelled and the entire SCG configuration at the UE is released. This results into delay and increased signalling overhead due to subsequent preparation of conditional PSCell addition.

Likewise, following a successful addition of SN through CPA, the prepared PSCells at the other candidate SNs are cancelled and configuration of other candidate SNs at the UE are released. This results into delay and increased signalling overhead in subsequent preparation of conditional PSCell change to other target SNs.

Turning now to FIGS. 1a-d there is shown, in a signalling flow chart, a first exemplary embodiment according to the different aspects of the disclosure.

The approach illustrated in connection with FIGS. 1a-d may be considered to be a conversion of a CPC configuration to a CPA configuration and may be summarized as follows: In response to the source SN initiated conditional SN change, the target SN includes a full RRC configuration in the ‘SgNB Addition Request Acknowledge’ message. The ‘SN Release Required’ message from sourthe ce SN to the MN, may update some of the CPC execution conditions to CPA conditions. The MN shall not initiate the release of source SN and target SN configurations; instead it shall use existing target SN CPC configurations for CPA. The MN reconfigures the UE with the new prepared CPA configuration and the updated execution conditions. The UE starts to evaluate the configured CPA conditions upon successful reconfiguration of updated CPA configuration.

In more detail, the source SN initiates the conditional SN change procedure by sending the ‘SN Change Required’ message (action 101). The MN requests the target SN(s) to allocate full config for the UE by indicating this in the ‘SN Addition Request’ (actions 102). The candidate target SNs respond back with ‘SN Addition Request Ack’ which includes the full RRC config for the prepared PSCells (actions 103).

The MN sends to the UE an RRC reconfiguration message (‘RRCReconfiguration*’) including the MN RRC reconfiguration message (‘RRCReconfiguration**’), the CPC configuration (i.e. a list of ‘RRCReconfiguration***’ messages) and associated execution conditions. Therein, an ‘RRCReconfiguration***’ message contains an RRCReconfiguration *** (with full configuration) received from the candidate SN and possibly an MCG configuration (action 104).

The UE applies the RRC configuration (in RRCReconfiguration*) excluding the CPC configuration, stores the CPC configuration and replies to the MN with an RRC reconfiguration complete message (‘RRCReconfigurationComplete*’) (action 105). The UE is thus configured with a configuration for a CPC as a first conditional cell operation.

The MN informs the source SN with ‘RRCReconfigutationComplete**’ for the source SN via the ‘SN Change Confirm’ message (action 106).

Upon initiating SN release (for example due to sync failure) to the MN, the SN updates the CPA condition and optionally updates the MeasGap configuration in “SNReleaseRequired” (action 107). The MN confirms this to the SN with ‘SN Release Confirm’ message (action 108). Upon receiving the ‘SN Release Required’ message, the MN updates the CPC condition/measurement events into CPA condition/measurement events. The MN refrains from releasing the prepared target SN's PSCell full configuration from the UE.

The MN sends a “RRCReconfiguration” to the UE (action 109). The ‘RRCReconfiguration’ message can be considered to be or comprise conversion information as described herein. More specifically, this message contains the updated conditions for the CPA and indicates to the UE to promote the source SCG of the CPC for use in CPA. As the release list does not contain the candidate PSCell IDs, the UE obtains an indication to maintain the configurations for the respective PSCells. The ‘RRCReconfiguration’ message also comprises updated measurement gap and configurations. The UE is thus configured to re-use the configuration originally provided for CPC for a subsequent second conditional cell operation, namely CPA in this case. The UE confirms the reconfiguration to the MN by sending the ‘RRCReconfigurationComplete’message (action 110).

The MN triggers the Xn-U Address Indication procedure to inform the source SN about the address of the selected target SN and if applicable, starts late data forwarding (actions 10a-10c).

As a result, the UE re-uses the full configuration of PSCells for CPA (which was received as part of the CPC configuration). The UE keeps the serving SCG configuration which will be used for CPA. The UE starts evaluating CPA conditions immediately after the SN release.

Thereafter, the ‘SN Status Transfer’ message is sent from the S-SN to the MN to inform the PDCP SN. Data forwarding takes place from the UPF to the S-SN and then from the S-SN to the MN. A ‘Secondary RAT Data Usage Report’ is snet from the S-SN to the MN. The ‘UE Context Release’ message is sent from the MN to the SN (actions 111, 112, 113).

The switch behavior from the T-SN of CPC into T-SN of CPA may be triggered by the release. For this, the targets may be indicated about the release with a respective signal e.g. with an indiciation to all target SNs. Then afterwards the switch from T-SN of CPC to S-SN of CPA may happen only for the T-SN. The switch from T-SN of CPC to T-SN of CPA happens in other potential T-SNs and S-SN.

Upon the CPA condition being satisfied for the T-SN, the UE applies the ‘RRCReconfiguration’ message (‘RRCReconfiguration**’) corresponding to the selected candidate PSCell, and sends an MN RRC reconfiguration complete message (‘RRCReconfigurationComplete**’) including an NR RRC reconfiguration complete message (‘RRCReconfigurationComplete***’) for the selected candidate PSCell, and the selected PSCell information to the MN (action 114).

The MN informs the SN that the UE has completed the reconfiguration procedure successfully via the ‘SNReconfigurationComplete’ message, including the ‘RRCReconfigurationComplete***’ response message (action 115).

Note: The MN does not send the SN Release Request message(s) to cancel CPA in the other target candidate SN(s), when configured to operate with this feature.

The UE performs a Random Access Procedure with T-SN (action 116). A “SN Status Transfer” message is sent from the MN to the T-SN (action 117). Data Forwarding from the UPF to the MN and then from the MN to the T-SN is performed. A ‘PDU Session Modification Indication’ message is sent from the MN to the AMF (action 118). A ‘Bearer Modification’ procedure is performed between the AMF and the UPF (action 119). An End Marker is sent from the UPF to the MN and then from the MN to the T-SN. A ‘PDU Session Modification Confirmation’ message is sent from the AMF to the MN (action 120).

The following advantages of the proposed solution can inter alia be identified:
The SN is added faster and immediately after the SN release.
The CPC configuration is re-used as CPA configuration which reduces substantially the signaling overhead and delay for re-initiating the preparation.
The serving SCG configuration is promoted as a candidate cell for CPA.

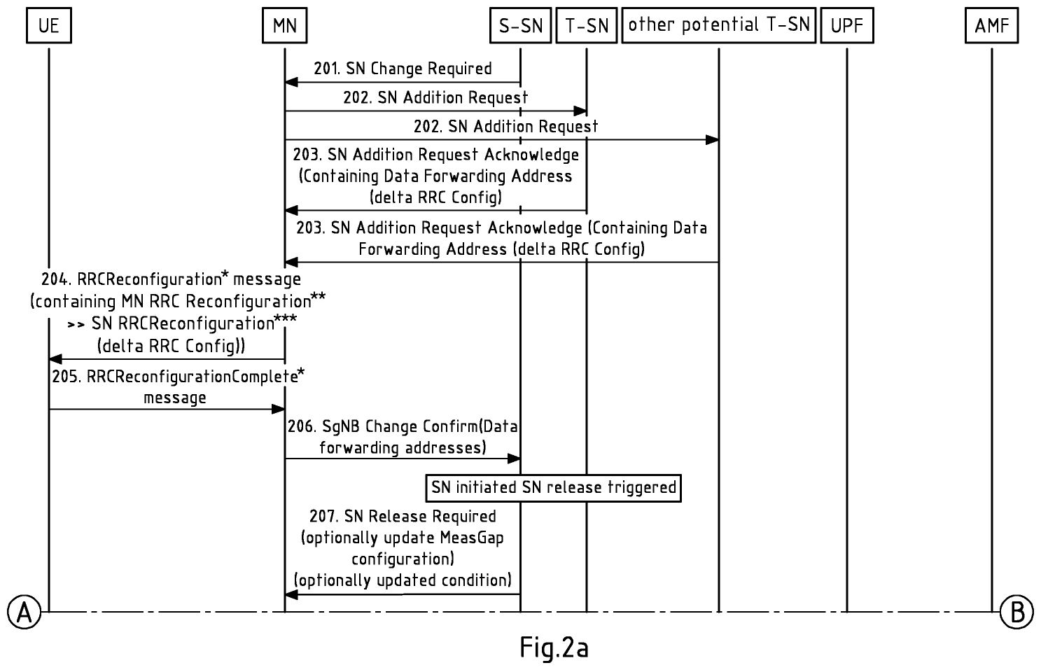

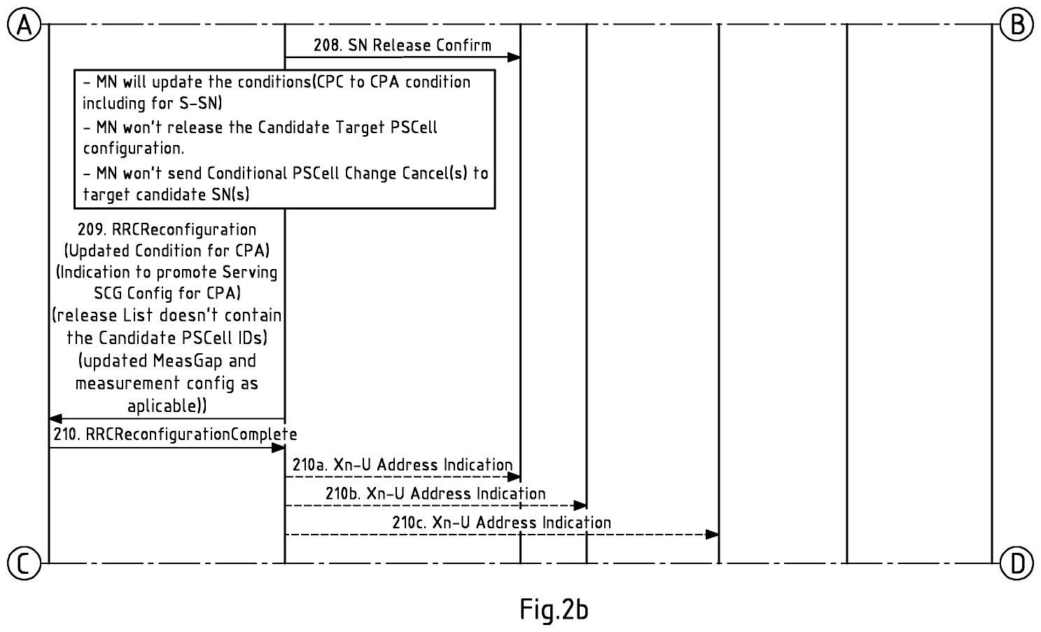

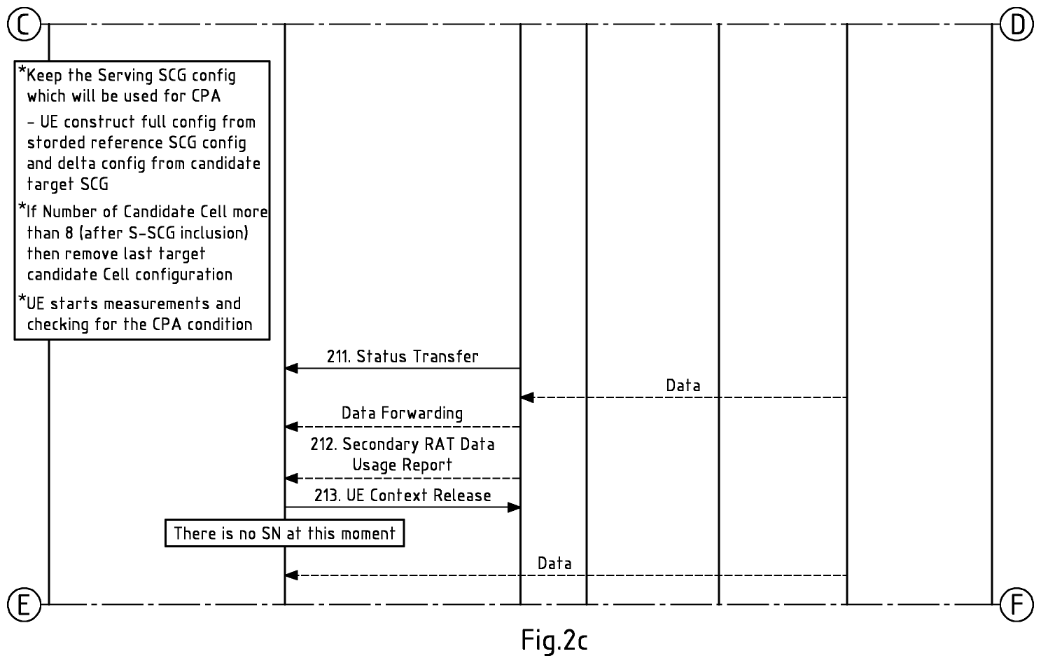

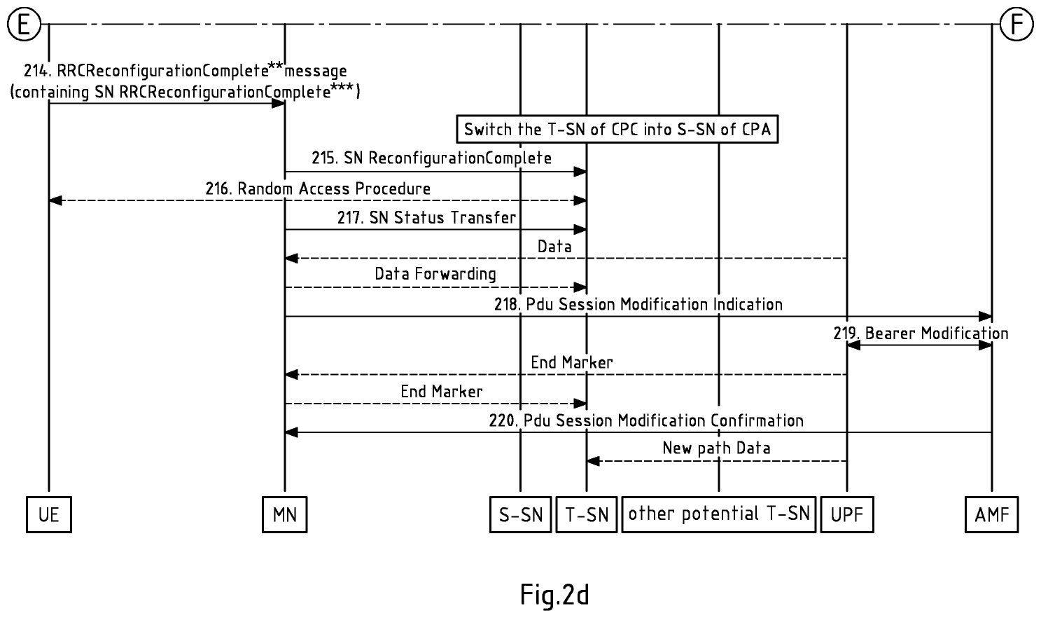

Turning now to FIGS. 2a-2d there is shown, in a signalling flow chart, a second exemplary embodiment according to the different aspects of the disclosure.

Similarly to the embodiment of FIGS. 1a-1d, the approach illustrated in connection with FIG. 2a- 2d may also be considered to be a conversion of a CPC configuration to a CPA configuration and may be summarized as follows: The target SN includes a delta RRC configuration in the ‘SgNB Addition Request Acknowledge’ message (as compared to the full RRC configuration in the embodiment of FIGS. 1a-1d). The ‘SN Release Required’ message from source the SN to the MN may convert the CPC condition into a CPA condition. The MN shall not initiate the release of the source SN and target SN configurations. Instead, the MN shall allow the UE to re-construct the CPA configuration using the full RRC configuration of the source SN and delta configurations of the target SNs. The MN may reconfigure the UE with the updated execution conditions for CPA (and if required with updated measurement gaps for target SN measurements). The UE starts to evaluate the configured CPA conditions.

Action 201 corresponds to action 101.

The MN then requests the target SN(s) to allocate the delta configuration for the UE by indicating this in the ‘SN Addition Request’ (action 202). The candidate target SNs respond back with ‘SN Addition Request Ack’, which includes the delta RRC configuration (action 203). The MN sends to the UE an RRC reconfiguration message (‘RRC reconfiguration*’) including the CPC configuration (i.e. a list of ‘RRCReconfiguration***’ messages) and associated execution conditions. Therein, an ‘RRCReconfiguration***’ message contains an ‘RRCReconfiguration****’ (with delta configuration) received from the candidate SN and possibly an MCG configuration.

Actions 205-208 correspond to actions 105-108. In contrast to the example from FIGS. 1a-1d, the UE then constructs the full configuration for candidate target SN's CPA configuration from the stored source SCG configuration and the delta configuration from the respective target SN. Actions 210-220 again correspond to actions 110-120.

The following advantages of the proposed solution can inter alia be identified:
The SN is added faster and immediately after the SN release.
The CPC configuration is re-used as a CPA configuration which reduces signalling overhead and delay of re-initiating the CPA preparation.
The serving SCG configuration is promoted as a candidate cell for CPA.
The full configurations of candidate cells are constructed by referring to the serving SCG configuration and the delta configuration received from the respective candidate cell as part of the CPC procedure.

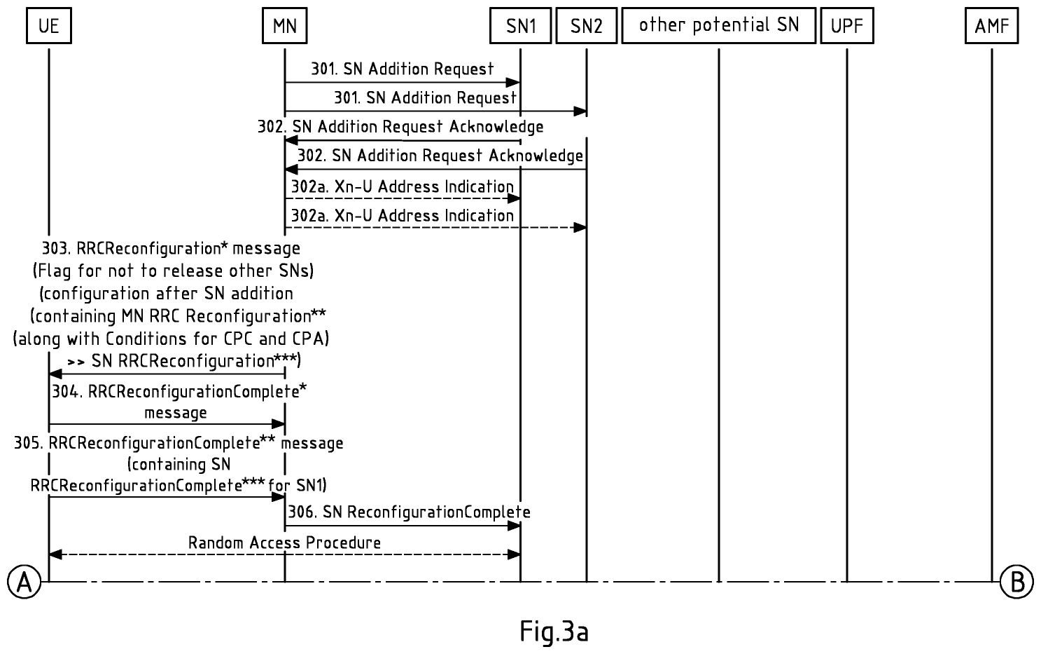

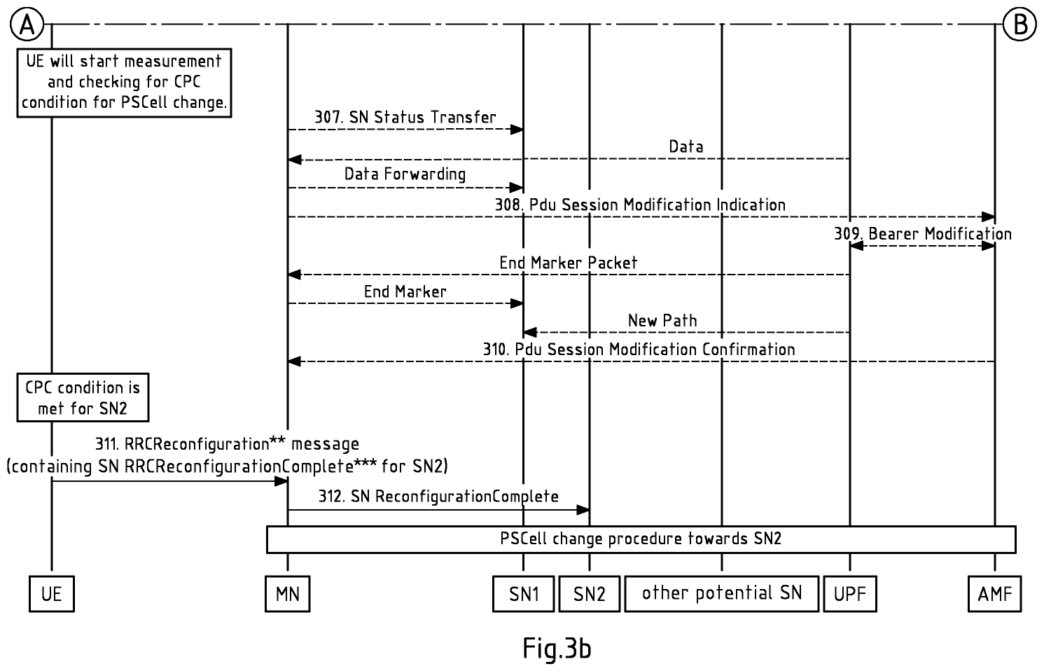

Turning now to FIGS. 3a-3b, there is shown, in a signalling flow chart, a third exemplary embodiment according to the different aspects of the disclosure.

The approach illustrated in connection with FIGS. 3a-3b may be considered to be a conversion of a CPA configuration to a CPC configuration and may be summarized as follows: The candidate SN includes the configuration of the prepared PSCells in the ‘SgNB Addition Request Acknowledge’ message as part of the CPA preparation procedure. The MN configures both CPA and CPC conditions for the candidate cells. The MN includes a flag in the ‘RRCReconfiguration*’ message to indicate not to release the other candidate SN's configuration after a successful conditional PSCell addition. The CPA configuration for the other SNs shall be used as a CPC configuration even after CPA is executed. The UE starts the measurement and checking for the CPC condition for the PSCell change just after the RACH success for the SN addition.

In more detail, The MN decides to configure CPA for the UE. The MN requests the target candidate SN to allocate resources by sending the ‘SGNB Addition Request’ message (actions 301). The target candidate SNs allocate respective resources and send the respective configuration in ‘SGNB Addition Request Ack’ messages (actions 302). For SN terminated bearers using MCG resources, the MN provides Xn-U DL TNL address information in the ‘Xn-U Address Indication’ message to the target candidate SNs (actions 302a).

The MN sends to the UE an RRC reconfiguration message (‘RRC reconfiguration*’) including the CPA configuration (i.e. a list of ‘RRC reconfiguration**’ messages) and associated execution conditions. Therein, a respective ‘RRC reconfiguration**’ message contains an ‘RRCReconfiguration***’ received from the candidate SN and possibly an MCG configuration. The MN configures both CPC and CPA conditions for all the candidate SNs. The MN includes a flag in the ‘RRCReconfiguration*’ message to indicate to the UE not to release the other candidate SNs configurations after the SN addition (action 303).

The UE applies the RRC configuration (in ‘RRC reconfiguration*’ message) excluding the CPA configuration, stores the CPA configuration and replies to the MN with an RRC reconfiguration complete message (‘RRCReconfigurationComplete*’) without any NR SN RRC response message (action 304).

The UE starts evaluating the CPA execution conditions. If the CPA execution condition of one candidate PSCell is satisfied, the UE applies the RRC reconfiguration message (‘RRC reconfiguration**’) corresponding to the selected candidate PSCell, and sends an MN RRC reconfiguration complete message (‘RRCReconfigurationComplete**’), including an NR RRC reconfiguration complete message (‘RRCReconfigurationComplete***’) for the selected candidate PSCell, and the selected PSCell information to the MN (action 305).

The MN informs the SN that the UE has completed the reconfiguration procedure successfully via the ‘SN ReconfigurationComplete’ message, including the ‘RRCReconfigurationComplete***’ response message (action 306). Note, that the UE performs synchronisation towards the selected PSCell indicated in the ‘RRCReconfiguration**’ message and performs the Random Access procedure towards the SCG. The UE-will start measurement and checking whether the CPC conditions for a PSCell change are met.

The MN sends the SN Status Transfer to inform the PDCP SN (action 307). Note that data forwarding will be started from the UPF to the MN and then from the MN to the SN1.

The MN sends the ‘PDU Session Modification Indication’ to the AMF. The AMF sends the ‘Bearer Modification’ to the UPF. The AMF sends the ‘PDU Session Modification Confirmation’ to the MN (actions 308-310). Note that the End Marker is sent from the UPF to the MN and then from the MN to the SN1. Then the DL data will be sent from the UPF directly to the SN1.

Note that at the UE the CPA configuration for other SNs are having full configuration, hence those CPA configurations can be used as CPC configuration, as well. The UE will start measurement and checking for the CPC conditions for the PSCell change just after the RACH success for the SN1 addition.

Upon CPC condition met for SN2, the PSCell change procedure can be started for SN2 by sending ‘RRCReconfigurationComplete**’ towards MN (action 311). A ‘SN ReconfigurationComplete’ message is sent from the MN to the SN2 (action 312).

The following advantages of the proposed solution can inter alia be identified:
The PSCell change to the SN2 will be faster (i.e. it can be just after the SN addition).
After the PSCell addition, there is no need to have an additional configuration (or message exchange towards the candidate SNs) for the CPC, which reduces the signaling overhead and delay of initiating the CPC after the CPA.

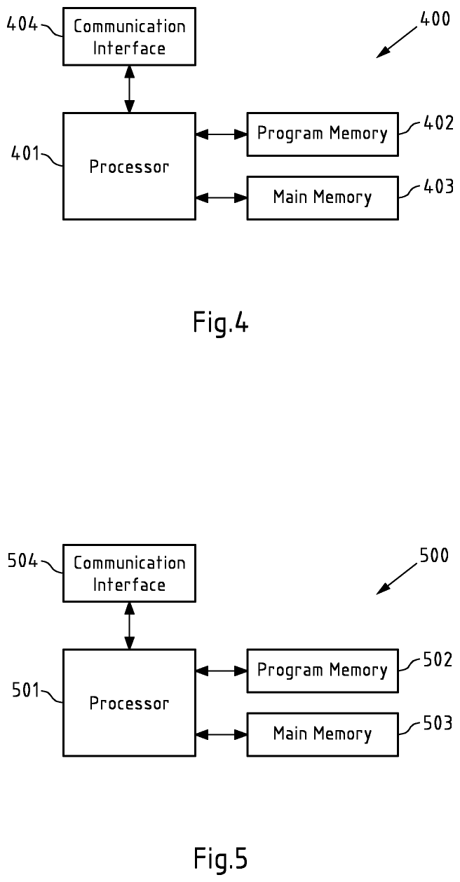

Turning now to FIG. 4, there is shown a block diagram of an example embodiment of a UE 400 according to the first aspect. For example, UE 400 may be one of a smartphone, a tablet computer, a notebook computer, a smart watch, a smart band, an IoT device or a vehicle or a part thereof.

UE 400 comprises a processor 401. Processor 401 may represent a single processor or two or more processors, which are for instance at least partially coupled, for instance via a bus. Processor 401 executes program code stored in program memory 402 (for instance program code causing UE 400 in connection with radio node 500 to perform one or more of the embodiments of a method according to the present disclosure or parts thereof, when executed on processor 401) and interfaces with a main memory 403. Program memory 402 may also contain an operating system for processor 401. Some or all of memories 402 and 403 may also be included into processor 401.

One or both of a main memory and a program memory of a processor (e.g. program memory 402 and main memory 403) could be fixedly connected to the processor (e.g. processor 401) or at least partially removable from the processor, for instance in the form of a memory card or stick.

A program memory (e.g. program memory 402) may for instance be a non-volatile memory. It may for instance be a FLASH memory (or a part thereof), any of a ROM, PROM, EPROM, MRAM or a FeRAM (or a part thereof) or a hard disc (or a part thereof), to name but a few examples. For example, a program memory may for instance comprise a first memory section that is fixedly installed, and a second memory section that is removable from, for instance in the form of a removable SD memory card.

A main memory (e.g. main memory 403) may for instance be a volatile memory. It may for instance be a DRAM memory, to give non-limiting example. It may for instance be used as a working memory for processor 401 when executing an operating system, an application, a program, and/or the like.

Processor 401 may further control a communication interface 404 (e.g. radio interface) configured to receive and/or transmit data and/or information. For instance, communication interface 404 may be configured to transmit and/or receive radio signals from a radio node, such as a master node or a secondary node, in particular as described herein. It is to be understood that any computer program code based processing required for receiving and/or evaluating radio signals may be stored in an own memory of communication interface 404 and executed by an own processor of communication interface 404 and/or it may be stored for example in memory 403 and executed for example by processor 401.

Communication interface 404 may in particular be configured to communicate according to a cellular communication system like a 2G/3G/4G/5G or future generation cellular communication system. UE 400 may use radio interface 404 to communicate with a radio node, such as a master node or a secondary node, in particular as described herein.

For example, communication interface 404 may further comprise a BLE and/or Bluetooth radio interface including a BLE transmitter, receiver or transceiver. For example, radio interface 404 may additionally or alternatively comprise a WLAN radio interface including at least a WLAN transmitter, receiver or transceiver.

The components 402, 403 and 404 of UE 400 may for instance be connected with processor 401 by means of one or more serial and/or parallel busses.

It is to be understood that UE 400 may comprise various other components. For example, UE 400 may optionally comprise a user interface (e.g. a touch-sensitive display, a keyboard, a touchpad, a display, etc.).

FIG. 5 is a block diagram of an example embodiment of a radio node 500, such as a master node 500 or a secondary node 500. For instance, radio node 500 may be configured for scheduling and/or transmitting signals to UE 400, and/or to one or more further radio nodes 500, as described above.

Radio node 500 comprises a processor 501. Processor 501 may represent a single processor or two or more processors, which are for instance at least partially coupled, for instance via a bus. Processor 501 executes a program code stored in program memory 502 (for instance program code causing radio node 500 to perform alone, together with UE 400, and/or together with one or more further radio nodes 500, one or more of the embodiments of a method according to the present disclosure or parts thereof, when executed on processor 501), and interfaces with a main memory 503.

Program memory 502 may also comprise an operating system for processor 501. Some or all of memories 502 and 503 may also be included into processor 501.

Moreover, processor 501 may control a communication interface 504 which is for example configured to communicate according to a cellular communication system like a 2G/3G/4G/5G cellular communication system. Communication interface 504 of radio node 500 may be realized by radio heads for instance and may be provided for communication between network device and terminal device.

The components 502, 503 and 504 of radio node 500 may for instance be connected with processor 501 by means of one or more serial and/or parallel busses.

It is to be understood that radio node 500 may comprise various other components.

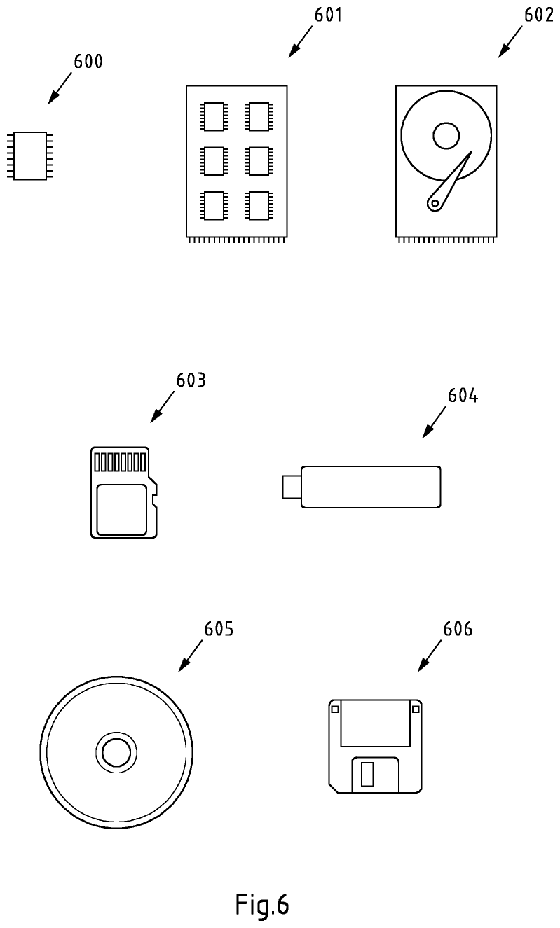

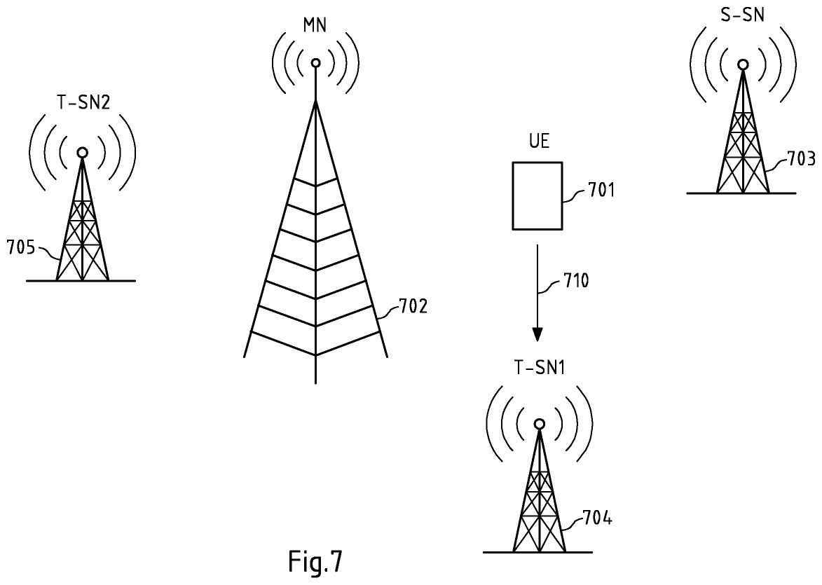

FIG. 6 is a schematic illustration of examples of tangible and non-transitory computer-readable storage media according to the present disclosure that may for instance be used to implement memory 402 of FIG. 4 or memory 502 of FIG. 5. To this end, FIG. 6 displays a flash memory 600, which may for instance be soldered or bonded to a printed circuit board, a solid-state drive 601 comprising a plurality of memory chips (e.g. Flash memory chips), a magnetic hard drive 602, a Secure Digital (SD) card 603, a Universal Serial Bus (USB) memory stick 604, an optical storage medium 605 (such as for instance a CD-ROM or DVD) and a magnetic storage medium 606.

Any presented connection in the described embodiments is to be understood in a way that the involved components are operationally coupled. Thus, the connections can be direct or indirect with any number or combination of intervening elements, and there may be merely a functional relationship between the components.

Further, as used in this text, the term ‘circuitry’ refers to any of the following:
(a) hardware-only circuit implementations (such as implementations in only analog and/or digital circuitry);
(b) combinations of circuits and software (and/or firmware), such as:
   (i) a combination of processor(s), or
   (ii) sections of processor(s)/software (including digital signal processor(s)), software, and memory(ies) that work together to cause an apparatus, such as a mobile phone, to perform various functions); and
(c) circuits, such as a microprocessor(s) or a section of a microprocessor(s), that require software or firmware for operation, even if the software or firmware is not physically present.

This definition of ‘circuitry’ applies to all uses of this term in this text, including in any claims. As a further example, as used in this text, the term ‘circuitry’ also covers an implementation of merely a processor (or multiple processors) or section of a processor and its (or their) accompanying software and/or firmware. The term ‘circuitry’ also covers, for example, a baseband integrated circuit or applications processor integrated circuit for a mobile phone.

Any of the processors mentioned in this text, in particular but not limited to processors 401 and 501 of FIGS. 4 and 5, could be a processor of any suitable type. Any processor may comprise but is not limited to one or more microprocessors, one or more processor(s) with accompanying digital signal processor(s), one or more processor(s) without accompanying digital signal processor(s), one or more special-purpose computer chips, one or more field-programmable gate arrays (FPGAS), one or more controllers, one or more application-specific integrated circuits (ASICS), or one or more computer(s). The relevant structure/hardware has been programmed in such a way to carry out the described function.

Moreover, any of the actions or steps described or illustrated herein may be implemented using executable instructions in a general-purpose or special-purpose processor and stored on a computer-readable storage medium (e.g. disk, memory, or the like) to be executed by such a processor.

References to ‘computer-readable storage medium’ should be understood to encompass specialized circuits such as FPGAs, ASICs, signal processing devices, and other devices.

As used herein, “at least one of the following: <a list of two or more elements>” and “at least one of <a list of two or more elements>” and similar wording, where the list of two or more elements are joined by “and” or “or”, mean at least any one of the elements, or at least any two or more of the elements, or at least all the elements.

The wording “A, or B, or C, or a combination thereof” or “at least one of A, B and C” may be understood to be not exhaustive and to include at least the following: (i) A, or (ii) B, or (iii) C, or (iv) A and B, or (v) A and C, or (vi) B and C, or (vii) A and B and C.

It will be understood that the embodiments disclosed herein are only exemplary, and that any feature presented for a particular exemplary embodiment may be used with any aspect of the present disclosure on its own or in combination with any feature presented for the same or another particular exemplary embodiment and/or in combination with any other feature not mentioned. It will further be understood that any feature presented for an example embodiment in a particular category may also be used in a corresponding manner in an example embodiment of any other category.

### ABBREVIATIONS

3GPP 3rd Generation Partnership Project
AMF Access and Mobility Management Function
CHO Conditional Handover
CPAC Conditional PSCell Addition or Change
CPC Conditional PSCell Change
CPA Conditional PSCell Addition
DC Dual Connectivity
LMF Location Management Function
MCG Master Cell Group
MN Master Node
NAS Non-Access Stratum
NR New Radio
PCell Primary cell of master cell group
PSCell Primary Cell of secondary cell group (SCG), Primary SCG Cell
RACH random access channel
SCG Secondary Cell Group
SN Secondary Node
S-SN Source Secondary Node
RRC Radio Resource Control
T-SN Target Secondary Node
UE User Equipment
UPF User Plane Function

### REFERENCES

[1] 3GPP TS 36.300 V 17.1.0 “Evolved Universal Terrestrial Radio Access (E-UTRA) and Evolved Universal Terrestrial Radio Access Network (E-UTRAN); Overall description; Stage 2 (Release 17)”, June 2022.
[2] 3GPP TS 37.340 V17.1.0 “Evolved Universal Terrestrial Radio Access (E-UTRA) and NR; Multi-connectivity; Stage 2 (Release 17)”, June 2022.

1-20. (canceled)

21. A user equipment configured to support dual connectivity operation towards a master node and a secondary node of a radio access network, the user equipment comprising at least one processor and at least one memory, the at least one memory storing instructions that, when executed by the at least one processor, cause the user equipment to:
obtain, from the master node, conversion information configuring the user equipment to in part re-use a configuration pertaining to a first conditional cell operation regarding one or more secondary nodes for a subsequent second conditional cell operation regarding the one or more secondary nodes.

22. The user equipment of claim 21, wherein the configuration pertaining to the first conditional cell operation comprises a configuration for at least two prepared candidate primary secondary cells, PSCells, of at least one target secondary node.

23. The user equipment of claim 21, wherein the user equipment is configured to establish a dual connectivity connection towards a primary cell, PCell, of the master node, and a primary secondary cell, PSCell, of the secondary node.

24. The user equipment of claim 21, wherein one of the following:
the first conditional cell operation is a conditional cell change, in particular a conditional PSCell change, CPC, and wherein the subsequent second conditional cell operation is a conditional cell addition, in particular a conditional PSCell addition, CPA; or
the first conditional cell operation is a conditional cell addition, in particular a conditional PSCell addition, CPA, and wherein the subsequent second conditional cell operation is a conditional cell change, in particular a conditional PSCell change, CPC.

25. The user equipment of claim 21, further caused to:
obtain, from the master node, said configuration pertaining to said first conditional cell operation regarding one or more secondary nodes;
wherein said configuration pertaining to said first conditional cell operation regarding one or more secondary nodes is obtained in a first configuration message, and wherein said conversion information is obtained in a subsequent second configuration message; or
wherein said configuration pertaining to said first conditional cell operation regarding one or more secondary nodes and said conversion information are obtained in a common configuration message.

26. The user equipment of claim 25, wherein said first, second and/or common configuration message are a higher layer message, in particular an RRCReconfiguration message.

27. The user equipment of claim 21, wherein the conversion information comprises one or more of the following:
an indication to maintain a configuration pertaining to a source secondary node, S-SN, or a serving secondary cell group, SCG, for said re-use of the configuration for the subsequent second conditional cell operation;
an indication to maintain a configuration pertaining to one or more target secondary nodes, T-SN, or target secondary cell groups, SCG, for said re-use of the configuration for the subsequent second conditional cell operation;
information indicating an updated measurement gap for said re-use of the configuration for the subsequent second conditional cell operation;
information indicating one or more updated execution conditions for said re-use of the configuration for the subsequent second conditional cell operation;
an indication to maintain, after a successful execution of the first conditional cell operation towards one secondary node, the configuration pertaining to the one or more remaining secondary nodes for said re-use of the configuration for the subsequent second conditional cell operation; and/or
information indicating one or more execution conditions to be used for the first conditional cell operation and one or more execution conditions to be used for the subsequent second conditional cell operation.

28. The user equipment of claim 21, the user equipment further caused to:
in response to obtaining said configuration pertaining to said first conditional cell operation, start evaluating one or more first execution conditions based on the configuration pertaining to the first conditional cell operation;
obtain said conversion information before the one or more first execution conditions based on the configuration pertaining to the first conditional cell operation are met or before the execution of the first conditional cell operation is completed;
in response to obtaining said conversion information, start evaluating one or more second execution conditions based on the re-used configuration for the second conditional cell operation.

29. The user equipment of claim 21, the user equipment further caused to:
in response to obtaining said configuration pertaining to said first conditional cell operation, start evaluating one or more first execution conditions based on the configuration pertaining to the first conditional cell operation;
determine whether the one or more first execution conditions for the configuration pertaining to the first conditional cell operation are met;
in case it is determined that the one or more first execution conditions for the configuration pertaining to the first conditional cell operation are met, apply the configuration pertaining to the first conditional cell operation, and start evaluating one or more second execution conditions based on the re-used configuration for the second conditional cell operation.

30. The user equipment of claim 28, the user equipment further caused to
determine whether the one or more second execution conditions for the re-used configuration for the second conditional cell operation are met;
in case it is determined that the one or more second execution conditions for the re-used configuration for the second conditional cell operation are met, apply the re-used configuration for the second conditional cell operation.

31. The user equipment of any of claim 21, wherein the configuration pertaining to the first conditional cell operation comprises a full configuration or delta configuration the first conditional cell operation.

32. The user equipment of claim 21, the user equipment further caused to:
determine whether the re-used configuration for the subsequent second conditional cell operation pertains to a number of candidate secondary cells exceeding a predetermined number; and
in case it is determined that the number of candidate secondary cells to which the re-used configuration for the subsequent second conditional cell operation pertains exceeds the predetermined number, removing one or more candidate secondary cells from the re-used configuration for the subsequent second conditional cell operation.

33. The user equipment of claim 21, wherein the conversion information comprises information indicating one or more updated execution conditions for said re-use of the configuration for the subsequent second conditional cell operation, wherein the configuration pertaining to the first conditional cell operation comprises one or more first execution conditions, and wherein the conversion information comprises one or more second execution conditions to be used for the subsequent second conditional cell operation.

34. The user equipment of claim 21, wherein a conditional cell operation relates to a conditional PSCell addition (CPA) or a conditional PSCell change (CPC).

35. A method, performed by a user equipment configured to support dual connectivity operation towards a master node and a secondary node of a radio access network, wherein the method comprises at least the following:
obtaining, from the master node, conversion information configuring the user equipment to in part re-use a configuration pertaining to a first conditional cell operation regarding one or more secondary nodes for a subsequent second conditional cell operation regarding the one or more secondary nodes.

36. A non-transitory computer-readable medium comprising program instructions that, when executed by a user equipment configured to support dual connectivity operation towards a master node and a secondary node of a radio access network, cause the user equipment to:
obtain, from the master node, conversion information configuring the user equipment to in part re-use a configuration pertaining to a first conditional cell operation regarding one or more secondary nodes for a subsequent second conditional cell operation regarding the one or more secondary nodes.

37. A master node of a radio access network, the master node and a secondary node of the radio access network configured to support dual connectivity operation towards a user equipment, the master node comprising at least one processor and at least one memory, the at least one memory storing instructions that, when executed by the at least one processor, cause the master node to:
provide, to the user equipment, conversion information configuring the user equipment to in part re-use a configuration pertaining to a first conditional cell operation regarding one or more secondary nodes for a subsequent second conditional cell operation regarding the one or more secondary nodes.

38. The master node of claim 37, further caused to:
obtain, from a source secondary node, S-SN, an indication to release the source secondary node, wherein, in response to said indication to release the source secondary node, said conversion information is provided to the user equipment.

39. The master node of claim 37, wherein said indication to release the source secondary node comprises one or more of:
information indicating an updated measurement gap for said re-use of the configuration for the subsequent second conditional cell operation;
information indicating an updated execution condition for said re-use of the configuration for the subsequent second conditional cell operation;

40. The master node of any of claims 37, further caused to one or more of the following:
update one or more execution conditions to be indicated to the user equipment as part of the conversion information for said re-use of the configuration for the subsequent second conditional cell operation;
refrain from releasing a configuration pertaining to one or more target secondary nodes, target secondary cell groups and/or primary secondary cells to be re-used for the subsequent second conditional cell operation.

41. A method, performed by a master node of a radio access network, the master node and a secondary node of the radio access network configured to support dual connectivity operation towards a user equipment, wherein the method comprises at least the following:
providing, to the user equipment, conversion information configuring the user equipment to in part re-use a configuration pertaining to a first conditional cell operation regarding one or more secondary nodes for a subsequent second conditional cell operation regarding the one or more secondary nodes.

42. A non-transitory computer-readable medium comprising program instructions that, when executed by a master node of a radio access network, the master node and a secondary node of the radio access network configured to support dual connectivity operation towards a user equipment, cause the master node to:
provide, to the user equipment, conversion information configuring the user equipment to in part re-use a configuration pertaining to a first conditional cell operation regarding one or more secondary nodes for a subsequent second conditional cell operation regarding the one or more secondary nodes.
